(19) United States
(12) Patent Application Publication
(10) Pub. No.: US 2016/0104342 A1
(43) Pub. Date: Apr. 14, 2016

(54) WINNING SYSTEM TRIGGERED RANDOMLY AND ACCUMULATIVELY

(71) Applicant: Tien-Shu HSU, Taichung City (TW)

(72) Inventor: Tien-Shu HSU, Taichung City (TW)

(21) Appl. No.: 14/511,759

(22) Filed: Oct. 10, 2014

(51) Int. Cl. G07F 17/32

(52) U.S. Cl. CPC G07F 17/326; G07F 17/3258

(57) ABSTRACT

A winning system determines whether a game system to enter a winning game, and includes a trigger element, an accumulation calculation element and a judgment unit. The trigger element randomly generates a trigger value between a designated upper limit value and a designated lower limit value. The accumulation calculation element generates a numerical value when a designated event takes place during the game system is running, and also accumulates the numerical value to generate an accumulated value. The judgment unit judges whether the accumulated value exceeds the trigger value when the accumulated value increases, and informs the game system to enter the winning game when the accumulated value has exceeded the trigger value. Thus the winning game is generated randomly and accumulatively, and generation frequency of the winning game also can be confined without being too fast or too slow, thereby meet use requirements.

### FIELD OF THE INVENTION

The present invention relates to a winning game and particularly to a determining system for entering a winning game.

### BACKGROUND OF THE INVENTION

Winning game is a game system that provides extra award. It provides a feature like this: after entering the winning game a certain amount of winning can be granted free without betting, hence gives players a feeling of winning a jackpot, therefore can attract more players to play the game.

The determining system of a conventional winning game has a set threshold value. When a specific symbol appears during players placing bets on the game system or the game system is running, value accumulation starts; in the event that the value exceeds the threshold value the game system activates the winning game to reward the players, thereby players' interest is aroused to continuously play the game, this also helps to increases business revenue of the game system.

However, in the determining system of such winning game the threshold value is fixed, hence the players can easily get the hang of the regularity. As a result, some players could try to observe the betting condition of other players on different game systems, and when the other players stop playing, they judge the betting condition of the game system and deliberate whether the winning game is likely to start; if yes, jump to playing; if no, give up playing. This phenomenon upsets the original purpose of rewarding the players.

To resolve the aforesaid phenomenon, some game systems adopt random probability to determine whether to enter the winning game. However, in practice it could happen that the winning game could occur consecutively in a short duration, or does not happen for a prolonged period of time. Hence it does not help much in boosting business revenue of the game system, and does meet use requirements.

### SUMMARY OF THE INVENTION

Therefore the primary object of the present invention is to provide a winning game that is generated randomly and accumulatively to meet use requirements.

To achieve the foregoing object the invention provides a winning system triggered randomly and accumulatively to determine whether a game system to enter a winning game. It includes a trigger element, an accumulation calculation element and a judgment unit. The trigger element randomly generates a trigger value between a designated upper limit value and a designated lower limit value. The accumulation calculation element is connected to the game system to generate a numerical value when a designated event takes place during the game system is running, and also accumulate and calculate the numerical value to generate an accumulated value and save the accumulated value in an interim storage unit. The judgment unit is connected to the trigger element, the accumulation calculation element and the game system, and judges whether the accumulated value exceeds the trigger value when the accumulated value increases, and informs the game system to enter the winning game when the accumulated value has exceeded the trigger value.

Thus, through the randomly generated trigger value that falls between the designated upper limit value and the designated lower limit value players cannot accurately guess the approximate value of the trigger value, hence can prevent the players from getting the hang of the generation regularity of the winning game. Moreover, since the trigger value is confined between the designated upper limit value and the designated lower limit value, the concern of the trigger value might be too big or too small also does not exist, hence generation frequency of the winning game can be controlled without being too fast or too slow, thus can meet use requirements.

The foregoing, as well as additional objects, features and advantages of the invention will be more readily apparent from the following embodiments and detailed description, which proceed with reference to the accompanying drawings. The embodiments merely aim for illustrative purpose and are not the limitation of the invention.

### BRIEF DESCRIPTION OF THE DRAWINGS

FIG. 1 is a block diagram of system architecture of the invention.

FIGS. 2A through 2C are schematic views of the invention on judging whether to trigger a winning game.

FIG. 3 is another schematic view of the invention for determining a designated upper limit value and a designated lower limit value.

FIG. 4 is yet another schematic view of the invention for determining a designated upper limit value and a designated lower limit value.

FIG. 5 is still another schematic view of the invention for determining a designated upper limit value and a designated lower limit value.

### DETAILED DESCRIPTION OF THE PREFERRED EMBODIMENTS

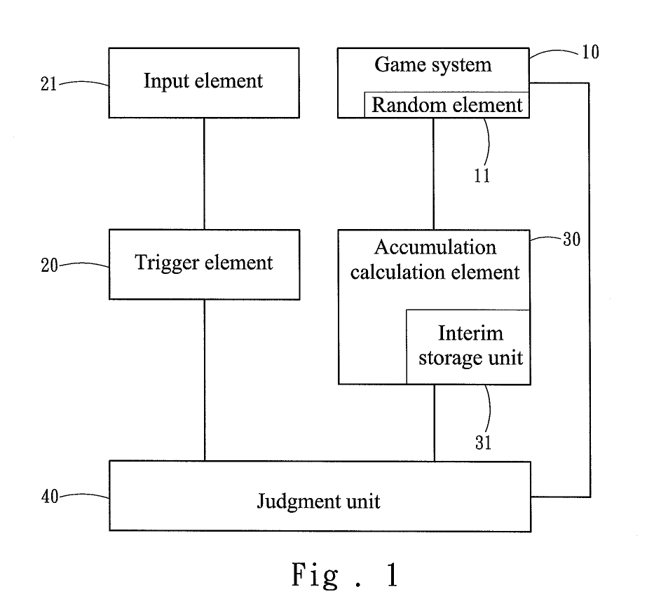

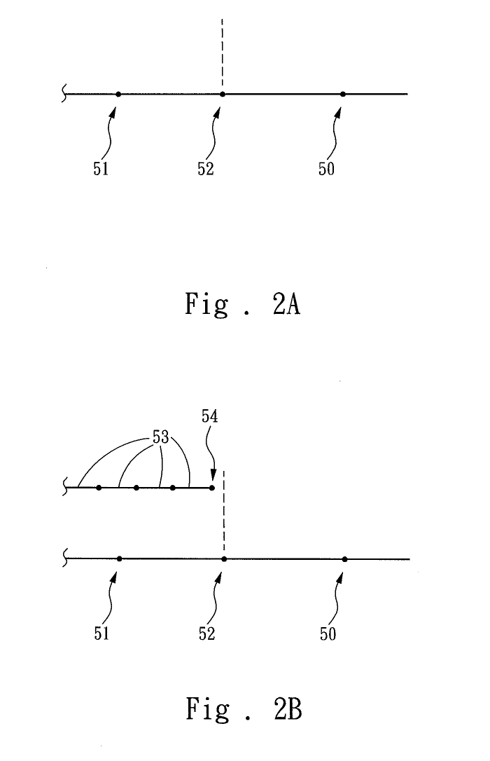

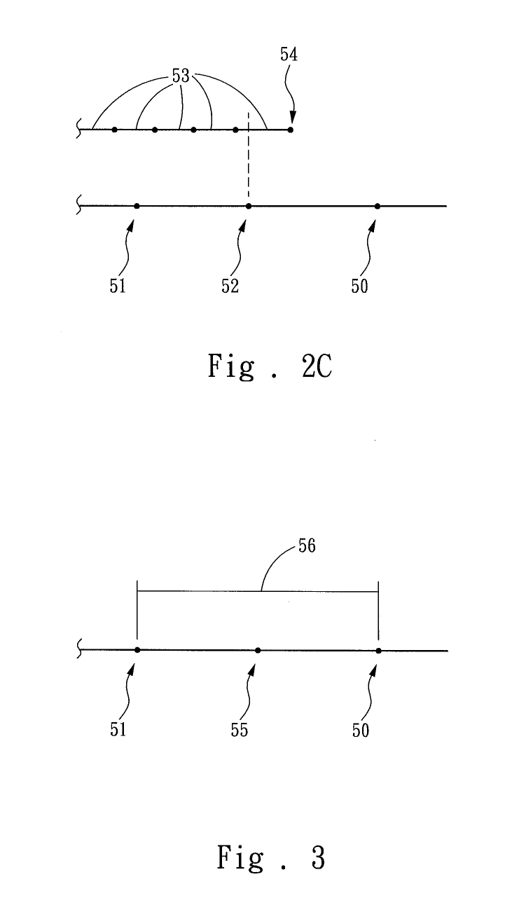

Please referring to FIGS. 1, and 2A through 2C, the present invention aims to provide a winning system that is triggered randomly and accumulatively to determine whether a game system 10 to enter a winning game. It includes a trigger element 20, an accumulation calculation element 30 and a judgment unit 40. The trigger element 20 randomly generates a trigger value 52 (as shown in FIG. 2A) between a designated upper limit value 50 and a designated lower limit value 51. The invention can further include an input element 21 connected to the trigger element 20. Through the input element 21 the designated upper limit value 50 and the designated lower limit value 51 can be directly entered.

The accumulation calculation element 30 is connected to the game system 10 to generate a numerical value 53 when a designated event takes place during the game system 10 is running, and also accumulate the numerical value 53 to generate an accumulated value 54 (as shown in FIG. 2B) and save the accumulated value 54 in an interim storage unit 31, namely the accumulated value 54 is formed by accumulating a plurality of the numerical value 53.

The judgment unit 40 is connected to the trigger element 20, the accumulation calculation element 30 and the game system 10, and judges whether the accumulated value 54 exceeds the trigger value 52 when the accumulated value 54 increases, and informs the game system 10 to enter the winning game when the accumulated value 54 has exceeded the trigger value 52 (as show in FIG. 2C).

Also referring to FIG. 3, the input element 21 also can be used to enter a middle value 55 and a variation range 56. The designated upper limit value 50 is derived by adding the middle value 55 and one half of the variation range 56, and the designated lower limit value 51 is derived by subtracting one half of the variation range 56 from the middle value 55.

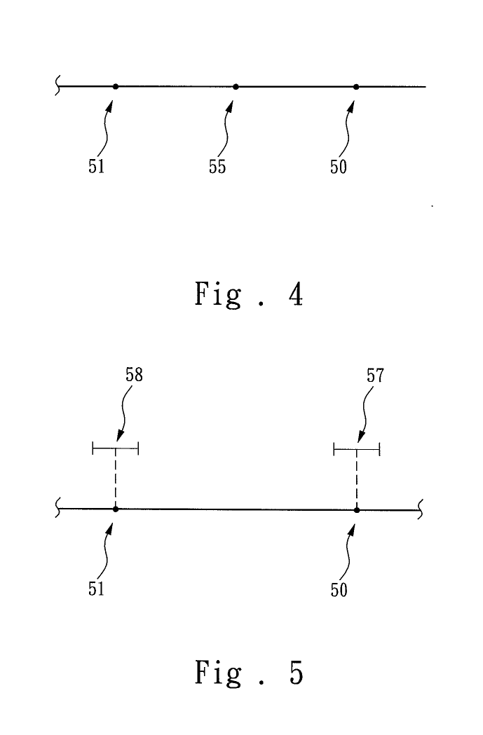

Also referring to FIG. 4, the input element 21 also can be used to enter the designated lower limit value 51 and the middle value 55. The designated upper limit value 50 is the sum of the middle value 55 and the difference of the designated lower limit value 51 and the middle value 55.

Also referring to FIG. 5, the input element 21 can also be used to enter an upper limit range value 57 and a lower limit range value 57. The designated upper limit value 50 is randomly selected from the upper limit range value 57, and the designated lower limit value 51 is randomly selected from the lower limit range value 58.

Furthermore, the designated event mentioned above is an event that can cause accumulation of the numerical value 53 while the game system 10 is running. For instance, during betting on the game system 10 the size of the numerical value 53 can be determined by the betting amount against the game system 10, namely the greater the betting amount the bigger the numerical value 53, such as the numerical value 53 is 1 for betting amount between 10 and 20, the numerical value 53 is 2 for betting amount between 21 and 50, and the numerical value 53 is 3 for betting amount between 51 and 100, and the like; or directly set the numerical vale 53 to be 1% of the betting amount, or the like.

The game system 10 of the invention can further include a random element 11 to randomly generate a random signal, and also can be set that the event is occurrence of betting on the game system 10 so that the random element 11 generates the random signal at the same time. More specifically, only the two events of betting on the game system 10 and generation of the random signal by the random element 11 are satisfied at the same time can be deemed as the designated event taking place. Hence the happening frequency of the random signal can be controlled via the random element 11 to adjust the accumulation speed of the numerical value 53. Similarly, the size of the numerical value 53 can be determined by the betting amount on the game system 10.

In addition, the designated event can be appearing of a designed symbol while the game system 10 is running, and the type and presence manner of the designated symbol can vary according to different types of the game system 10; take a slot machine as an example, the designated symbol can be presented via rolling wheels, hence when the rolling wheels present the designated symbol, the designated event is deemed taking place.

As a conclusion, the invention, by randomly generating the trigger value 52 between the designated upper limit value 50 and the designated lower limit value 51, and by further making the designated upper limited value 50 and the designated lower limit value 51 floating, can make the trigger value 50 falling randomly between the designated upper limit value 50 and the designated lower limit value 51, hence players cannot accurately guess the approximate value of the trigger value 52, in other words, the players cannot get a hang of the generation regularity of the winning game. Through the designated upper limit value 50 and the designated lower limit value 51, the trigger value 52 can be confined without too big or too small, hence can make generation frequency of the winning game not too fast or too slow, thereby can meet use requirements.

What is claimed is:

1. A winning system triggered randomly and accumulatively to determine whether a game system to enter a winning game, comprising:
a trigger element to randomly generate a trigger value between a designated upper limit value and a designated lower limit value;
an accumulation calculation element which is connected to the game system and accumulates a numerical value generated by the game system when a designated event takes places in the game system during proceeding to generate an accumulated value and save the accumulated value in an interim storage unit; and
a judgment unit which is connected to the trigger element, the accumulation calculation element and the game system, and judges whether the accumulated value has exceeded the trigger value after the accumulation value has increased, and informs the game system to enter the winning game when the accumulated value exceeds the trigger value.

2. The winning system of claim 1 further including an input element connected to the trigger element to input a middle value and a variation range, the designated upper limit value being the sum of the middle value and one half of the variation range, and the designated lower limit value being a net value derived by subtracting one half of the variation value from the middle value.

3. The winning system of claim 1 further including an input element connected to the trigger element to input the designated lower limited value and a middle value, the designated upper limit value being the sum of the middle value and the difference between the designated lower limit value and the middle value.

4. The winning system of claim 1 further including an input element connected to the trigger element to input the designated upper limit value and the designated lower limited value.

5. The winning system of claim 1 further including an input element connected to the trigger element to input an upper limit range value and a lower limit range value, the designated upper limit value being randomly selected from the upper limit range value, the designated lower limit value being randomly selected from the lower limit range value.

6. The winning system of claim 1, wherein the designated event is betting on the game system.

7. The winning system of claim 6, wherein the size of the numerical value is determined by the amount of the betting on the game system.

8. The winning system of claim 1, wherein the game system further includes a random element to randomly generate a random signal, and the designated event is betting on the game system and the random element generates the random signal simultaneously.

9. The winning system of claim 8, wherein the size of the numerical value is determined by the amount of the betting on the game system.

10. The winning system of claim 1, wherein the designated event is appearing of a designated symbol while the game system is proceeding a game.
